(19) United States
(12) Patent Application Publication
(10) Pub. No.: US 2016/0029662 A1
(43) Pub. Date: Feb. 4, 2016

(54) STICK FOR HOLDING A FOODSTUFF LIKE ICE CREAM, SWEET OR OTHER TREAT ON A STICK

(71) Applicant: OÜ Blue Triton, Tallinn (EE)

(72) Inventor: KAIO KIVIMA, Tallinn (EE)

(73) Assignee: OÜ BLUE TRITON, Tallinn (EE)

(21) Appl. No.: 14/559,569

(22) Filed: Dec. 3, 2014

(30) Foreign Application Priority Data
Jul. 29, 2014 (EE) U201400052

(51) Int. Cl. A23G 9/50; A23G 3/56

(52) U.S. Cl. CPC A23G 9/503; A23G 3/563

(57) ABSTRACT

The present invention relates to a stick for holding a foodstuff such as an ice cream, sweet or other treat. In a usage situation one end of the stick is intended to be positioned into the foodstuff and the other end of the stick is intended for holding a stick. Between the ends of the stick a groove is made, which is perpendicular to the longitudinal direction of the stick and where into the groove an absorbent element made of fluid absorbent material is placed.

### TECHNICAL FIELD

The invention relates to a stick for holding a foodstuff like ice-cream, sweet or other treat on a stick, or in other words, a stick for a treat on a stick. More particularly, the invention relates to the above-mentioned type of stick, which is fitted with a means for catching the trickles or drips of the product (for example, ice-cream, sweet, frozen juice or other treat) on the end of the stick that has started to melt or drip.

### BACKGROUND ART

From the patent U.S. Pat. No. 5,770,250 of the United States of America (published on Jun. 23, 1998), confection on a stick is known, associated with a so-called drip absorber or an absorbing element with a sponge as the absorbing article on the stick for the purpose of catching trickles and/or drips. In this solution the absorbing element can be reused after washing.

From the patent application US2006127542A1 of the United States of America (published on Jun. 15, 2006), a drip absorber for frozen treats on a stick is known, or an absorbing element is made of cellulose-based absorbing material. In this solution the absorbing element is known to be discardable after use, or optionally it is washable and reusable.

From the German patent specification DE811703C (published on Aug. 23, 1951), a brush, in particular a shaving brush fitted with an absorbing element from absorbing material for catching drips and/or trickles is used. In this known solution, the absorbing element is placed on the handle of the brush.

### DISCLOSURE OF INVENTION

The shortcoming of the above-mentioned solutions known from the state of the art is that using them in the manufacturing of the stick treats, such as lollipops and/or ice-cream on stick, is complicated. This is in particular due to the fact that the absorbing element projecting from the external surface of the stick interferes with and/or obstructs the use of such a stick, since the projecting absorbing element interferes with the automatic handling of the stick in the production lines or makes this handling virtually impossible without substantial and expensive technological improvement of the production line.

Also, in the above-cited earner solutions, the absorbing element is placed on the stick of the ready stick treat (stick product) after the production of the stick treat is completed.

One of the aims of the invention is to provide a stick for the production of stick treats like ice-cream on a stick, lollipops and similar, where the stick is fitted with an absorbing element beforehand, i.e. before the production of the stick treat itself, and which can be used in the process of stick treat production instead of the conventional stick that has no absorbing element.

In other words, the aim of the invention is to provide for the production of stick treats, in particular ice-cream on a stick and lollipops, a stick, which is fitted with an absorbing element but at the same time has a configuration that enables stick to be used on the existing stick treat (stick-mounted product) production lines where plain sticks without an absorbing element have been used until now.

The subject of the invention is a stick for holding a foodstuff such as an ice-cream, sweet or other treat on a stick.

The stick according to the invention is intended for the use with a foodstuff wherein the end of the stick is inserted into the foodstuff, in particular in a stick treat like lollipop or ice-cream on a stick or any other treat that is heldable/consumable when the treat is placed on a stick.

In the part of the stick, which in use is located between the end of the stick inserted into the foodstuff and the other end of the stick intended for holding the stick, as seen from said other end of the stick, a continuous groove is made, which is perpendicular to the longitudinal direction of the stick and where into said groove an absorbing element made of liquid absorbing material is placed.

In a preferred embodiment of the invention the external surface of the absorbing element of liquid absorbing material in the groove is flush with the external surface of the stick adjacent with the sides of the groove.

Preferably the liquid absorbing material of the absorbing element is cellulose-based.

Most preferably the liquid absorbing material of the absorbing element is cotton-based.

However, the liquid absorbing material of the absorbing element can also be made of liquid absorbent synthetic material.

The groove intended for the absorbing element is situated between the end of the stick intended for being inserted into the foodstuff and the other end of the stick intended for holding the stick.

According to another embodiment the groove is symmetrical in relation to the ends of the stick.

The cross-section of the stick can be mainly rounded, elliptical or mainly tetragonal, preferably rectangular. Likewise, the cross-section of the stick can have a polygonal shape.

According to the preferred embodiment of the invention in the longitudinal direction of the stick the absorbing element in the groove has a width at least equal to two times the outside diameter of the stick.

According to an another preferred embodiment of the invention in the longitudinal direction of the stick the absorbing element in the groove has a width at least equal to three times the outside diameter of the stick.

The stick can be made of wood, cellulose or plastic.

### BRIEF DESCRIPTION OF DRAWING

The present invention is hereinafter described in detail with references to the accompanying schematic drawings, wherein:

FIG. 1 is schematic depiction of a stick of present invention with the absorbing element made of liquid absorbing material placed on a stick, where the end of the stick is inserted into a foodstuff, such as for example ice cream or treat;

FIG. 2 shows schematic side view of a stick according to invention depicted on FIG. 1;

FIG. 3 shows schematic side view of an assembly of the stick according to the invention and the absorbing element made from liquid absorbing material depicted on FIG. 1.

### MODES FOR CARRYING OUT THE INVENTION

The stick 1 according to the invention comprises in the lengthwise direction of the stick, more or less in or near of the middle part of the stick, a continuous groove 2, wherein the absorbing element 3 made of liquid absorbing material is placed.

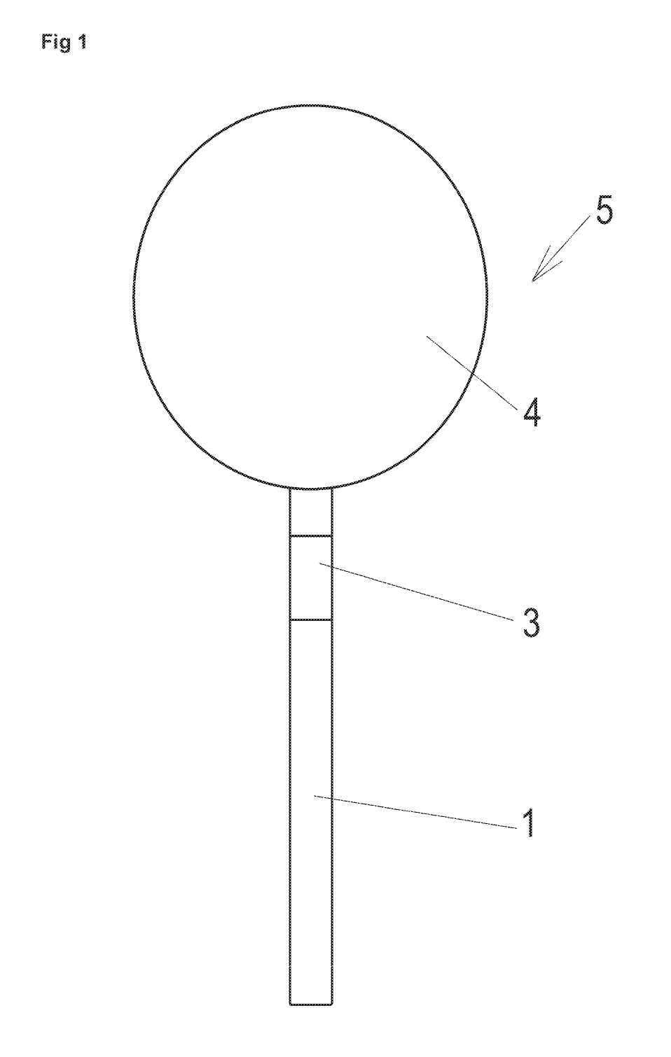

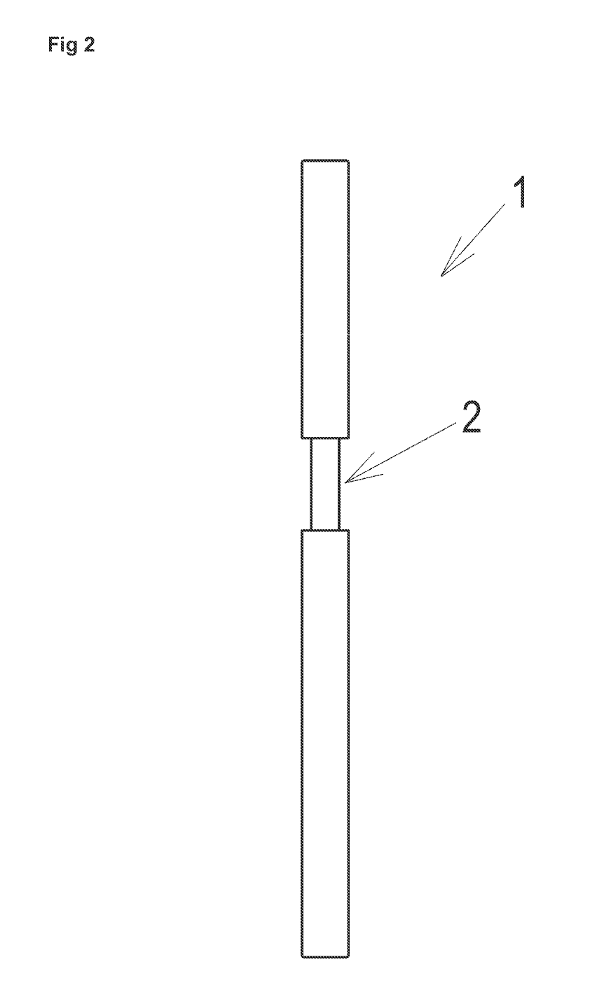

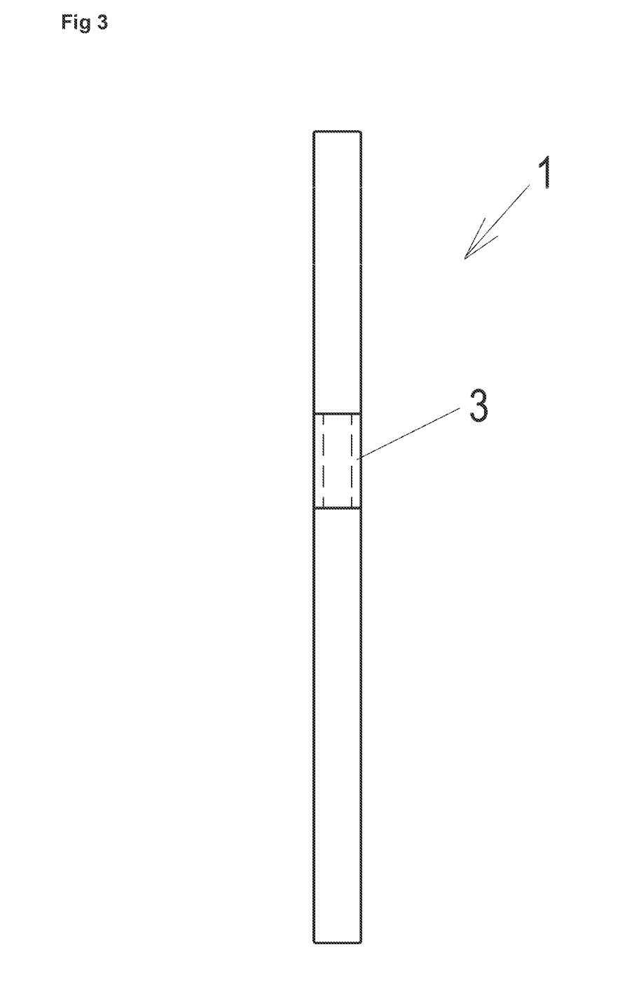

In the embodiment depicted in FIGS. 1 to 3, the groove 2 with absorbing element 3 inside it, is in the lengthwise direction of the stick 1 near the middle part of the stick, so that the shorter part of stick 1 on the one side of the absorbing element 3 is intended to be placed inside the treat 4 (see FIG. 1) and the longer part of the stick 1 on the other side of the absorbing element 3 is intended for holding a ready stick treat 5 in hand.

In the embodiment depicted in the figures, the absorbing element 3 is made of cotton-based material. However, any other cellulose-based liquid absorbing material can be used for this.

Likewise, the absorbing element 3 can be made of a synthetic liquid absorbing material.

The stick 1 is made of wood, wood pulp, cellulose or plastic.

In the embodiment depicted in the figures, the stick 1 is basically cylindrical, i.e. its cross-section is round.

However, the stick can be made with any cross-section, such as, for example, with a tetragonal cross-section, an elliptical cross-section, a polygonal cross-section, an oblate cross-section (for example, a rectangular cross-section).

In the example depicted in the figures, the external surface of the absorbing element 3 in the groove 2 is flush with the cylindrical external surface of the stick 1. Such a configuration allows a use of a stick according to the invention instead of the conventional sticks without absorbing elements in the production of stick treats easily and without any additional measures.

In the embodiment depicted in the figures, the absorbing element 3 fastens to the groove 2 by means of its elasticity. Optionally the absorbing element can be clued into the groove. In the embodiment depicted in the figures, the absorbing element 3 has a tubular shape.

For the person skilled in the art it is obvious, that the invention is not limited to the embodiments described above and depicted in accompanying drawings, but within the scope of the claims other embodiments are conceivable.

1. A stick for holding a foodstuff like ice-cream, sweet or other treat on the stick, where in use one end of the stick is intended to be paced into the foodstuff and the other end of the stick is intended for holding a stick, where between the ends of the stick a continuous groove is made which is perpendicular to the longitudinal direction of the stick and where into said groove an absorbing element made of liquid absorbing material is placed.

2. A stick according to according to claim 1, where the external surface of the absorbing element made of liquid absorbing material and lying in the groove is flush with the external surface of the stick adjacent with the side wads of the groove.

3. A stick according to according to claim 1, where the absorbing element is made of cellulose-based liquid absorbing material.

4. A stick according to according to claim 1, where the absorbing element is made of cotton-based liquid absorbing material.

5. A stick according to according to claim 1, where the groove is symmetric in relation to the ends of the stick.

6. A stick according to according to claim 1, where the cross-section of the stick is round.

7. A stick according to according to claim 1, where the cross-section of the stick is mainly elliptical.

8. A stick according to according to claim 1, where the cross-section of the stick is mainly quadrangular, preferably rectangular.

9. A stick according to according to claim 1, where the longitudinal direction of the stick the absorbing element in the groove has a width at least equal to two times the outside diameter of the stick.

10. A stick according to according to claim 1, where the longitudinal direction of the stick the absorbing element in the groove has a width at least equal to three times the outside diameter of the stick.

11. A stick according to according to claim 1, where the stick is made of wood, cellulose or plastic.

12. A stick according to according to claim 1, where the stick is intended for use with a foodstuff wherein one end of the stick is inserted into said foodstuff, particularly in a lollipop or ice cream on a stick.
